(19) United States
(12) Patent Application Publication
(10) Pub. No.: US 2026/0094743 A1
(43) Pub. Date: Apr. 2, 2026

(54) NdFeB MAGNET

(71) Applicants: Ningbo Konit Industries Inc., Ningbo (CN); Ningbo Konit HEFENG NEW Material Co.,Ltd., Ningbo (CN); Ningbo Konit Xinfeng Precision Manufacturing Co., Ltd., Ningbo (CN); Ningbo Konit & Nihon Magnetic Material Inc., Ningbo (CN); BEIJING ZHONG KE SAN HUAN HI-TECH CO., LTD., Beijing (CN)

(72) Inventors: Chao CHEN, Ningbo (CN); Lijun DING, Ningbo (CN); Chenghong GU, Ningbo (CN); Wei ZHU, Beijing (CN); E NIU, Beijing (CN); Die HU, Beijing (CN)

(21) Appl. No.: 19/295,983

(22) Filed: Aug. 11, 2025

(30) Foreign Application Priority Data
Sep. 29, 2024 (CN) 202411384796.5

(51) Int. Cl. H01F 1/057; C22C 33/02; C22C 38/00; C22C 38/06; C22C 38/10; C22C 38/14; C22C 38/16; H01F 41/02

(52) U.S. Cl. CPC H01F 1/0577; C22C 33/02; C22C 38/002; C22C 38/005; C22C 38/06; C22C 38/10; C22C 38/14; C22C 38/16; H01F 41/0266

(57) ABSTRACT

A NdFeB magnet includes main phase grains, thin-layer grain boundary phases, and triangular region grain boundary phases. The distribution of the triangular region grain boundary phase within the NdFeB magnet satisfies 0.057≤S₁/S≤0.073. The NdFeB magnet includes R, M, M₁, Co, B, and T. R represents one or more selected from Nd, Pr, Ho, Ce, Gd, Dy, and Tb. M represents one or more selected from Al, Cu, and Ga. M₁ represents one or more selected from Ti, Zr, Nb, W, and V. T is selected from Fe and other impurity elements. The content of R in the NdFeB magnet is in a range of 28 to 32 wt %, and the content of M₁ is in a range of 0.4 to 1.0 wt %. The triangular grain boundary phase includes the R-T-M-Co phase. The content of Co in the R-T-M-Co phase is in a range of 6.2 to 10.4 at %.

### CROSS-REFERENCE TO RELATED APPLICATION

This application claims priority to Chinese Application No. 202411384796.5, filed on Sep. 29, 2024, the entire content of which is incorporated herein by reference.

### TECHNICAL FIELD

The present disclosure relates to the field of NdFeB magnets and, in particular, to a NdFeB magnet and its preparation method.

### BACKGROUND

Sintered NdFeB permanent magnetic materials exhibit high magnetic performance and cost-effectiveness, making them the most promising magnetic materials currently available. As the application scenarios for NdFeB permanent magnetic materials become increasingly demanding, the performance requirements have also intensified. To enhance coercivity and improve heat resistance, grain boundary diffusion processes to diffuse heavy rare earth elements from the surface of the magnet into its interior has been frequently used recently. This results in a concentration of heavy rare earth elements in the shell region of the main phase grains, thereby improving the coercivity of the magnet while suppressing the reduction of remanence (Br).

However, due to the limited diffusion depth of heavy rare earth elements, enrichment inside the main phase grains can occur, leading to a decrease in remanence and a minimal increase in Hcj. This results in low utilization efficiency of heavy rare earth elements, increasing production costs and causing rapid degradation of the performance enhancement of the magnet.

To reduce the usage of heavy rare earth elements, elements such as Ti and Zr are often used to partially substitute for Dy. This is achieved by forming borides and other high-melting-point precipitates during the sintering process, which impede abnormal grain growth and enhance the coercivity of the magnet. However, when the amount of Ti, Zr, and similar elements is further increased (i.e., when M₁ exceeds 0.4 wt %), the Nd-rich phase at the grain boundaries may be distributed in a thin continuous layer between the grains, which can hinder interactions between the grains. Nonetheless, its effectiveness in achieving magnetic isolation is limited, and while there may be a slight improvement in coercivity, this can adversely affect the squareness of the magnet. Moreover, further increasing the amounts of Ti, Zr, and similar elements results in less smooth main phase grains within the magnet, leading to defects at the edges, which similarly limits the extent of coercivity enhancement and restricts the overall improvement in magnetic performance.

### SUMMARY

The present disclosure aims to provide a NdFeB magnet and a method for its preparation. The method provided by the disclosure effectively optimizes the microstructure of the resulting NdFeB magnet, resulting in a higher roundness of the main phase grains. Additionally, the area fraction of the thin-layer grain boundary phase is reduced, while the area fraction of the triangular grain boundary phase is increased. Furthermore, the atomic percentage of Co in the R-T-M-Co phase within the triangular grain boundary phase is increased, thereby endowing the NdFeB magnet with enhanced coercivity and squareness.

The first aspect of the present disclosure provides a NdFeB magnet, where the NdFeB magnet comprises main phase grains, a thin-layer grain boundary phase, and a triangular grain boundary phase. The distribution of the triangular grain boundary phase within the NdFeB magnet satisfies the following:

$$0.057 \leq {S}_{1} / S \leq 0.073 ;$$

where S₁/S represents the ratio of the area S₁ of all triangular grain boundary phases to the total area S of the cross-section of the NdFeB magnet.

The NdFeB magnet includes R, M, M₁, Co, B, and T; R represents one or more selected from Nd, Pr, Ho, Ce, Gd, Dy, and Tb; M represents one or more selected from Al, Cu, and Ga; M₁ represents one or more selected from Ti, Zr, Nb, W, and V; T is selected from Fe and other impurity elements. The content of R in the NdFeB magnet is in the range of 28 to 32 wt %, and the content of M₁ is in the range of 0.4 to 1.0 wt %.

The triangular grain boundary phase comprises an R-T-M-Co phase, where the content of Co in the R-T-M-Co phase is in the range of 6.2 to 10.4 at %.

In some embodiments, in the NdFeB magnet, the content of R is in the range of 28 to 32 wt %, the content of M₁ is in the range of 0.4 to 1.0 wt %, the content of Co is in the range of 0.4 to 2 wt %, the content of Cu is in the range of 0.1 to 0.25 wt %, the content of Ga is in the range of 0.1 to 0.25 wt %, the content of Al is in the range of 0.05 to 1.2 wt %, the content of B is in the range of 0.85 to 1.05 wt %, with the balance being Fe and other impurity elements. In some embodiments, R does not include Ce and Gd.

In some embodiments, the content of Ti in M₁ is in the range of 0 to 0.4 wt %, and the content of Zr is in the range of 0.25 to 0.7 wt %.

In some embodiments, M₁ includes at least one of Ti or Zr; when the content of Ti in M₁ is equal to 0 wt %, the content of Zr is greater than or equal to 0.3 wt %, and when the content of Zr in M₁ is equal to 0 wt %, the content of Ti is greater than or equal to 0.2 wt %.

In some embodiments, the content of R in the R-T-M-Co phase is in the range of 38 to 90 at %.

In some embodiments, the content of Cu in the R-T-M-Co phase is in the range of 4 to 9.7 at %, and the content of Ga is in the range of 2.9 to 6 at %.

In some embodiments, the distribution of the R-T-M-Co phase within the triangular grain boundaries satisfies the following:

$$0.162 \leq {S}_{2} / {S}_{1} \leq 0.18 ;$$

where S₂/S₁ represents the ratio of the area S₂ of the R-T-M-Co phases within the triangular grain boundaries to the area S₁ of all triangular grain boundary phases within the cross-section of the NdFeB magnet.

In some embodiments, the triangular grain boundary phase further comprises an R₆T₁₃M₁ phase, where the distribution of the R₆T₁₃M₁ phase satisfies the following:

$$0.8 \leq {S}_{3} / {S}_{1} \leq 0.815 ;$$

where S₃/S₁ represents the ratio of the area of the R₆T₁₃M₁ phases within the cross-section of the NdFeB magnet to the area of the triangular grain boundary phases within the cross-section of the NdFeB magnet.

In some embodiments, the roundness of the main phase grains is in the range of 0.6 to 0.9, and the average grain size of the main phase grains is in the range of 3.5 to 4.5 μm.

A second aspect of the present disclosure provides a method for preparing a NdFeB magnet, which comprises:
forming raw alloy powder into a compact;
sintering the compact; and aging the compact;
where the process of aging the compact includes a first aging treatment, a second aging treatment, and a third aging treatment;
where the temperature of the first aging treatment is in the range of 870 to 940° C. with a holding time of 0.5 to 4 h; the temperature of the second aging treatment is in the range of 420 to 670° C. with a holding time of 1 to 10 h; and the temperature of the third aging treatment is in the range of 620 to 670° C. with a holding time of 1 to 10 h;
where the raw alloy powder comprises R, M, M₁, Co, B, and T, with R representing one or more selected from of Nd, Pr, Ho, Ce, Gd, Dy, and Tb; M representing one or more selected from of Al, Cu, and Ga; M₁ representing one or more selected from of Ti, Zr, Nb, W, and V; and T selected from Fe and other impurity elements; and where the content of R in the NdFeB magnet is in the range of 28 to 32 wt %, and the content of M₁ is in the range of 0.4 to 1.0 wt %.

In some embodiments, the temperature for the second aging treatment is in the range of 450 to 660° C., and the temperature for the third aging treatment is in the range of 630 to 670° C.

In some embodiments, in the raw alloy powder, the content of R is in the range of 28 to 32 wt %, the content of M₁ is in the range of 0.4 to 1.0 wt %, the content of Co is in the range of 0.4 to 2 wt %, the content of Cu is in the range of 0.1 to 0.25 wt %, the content of Ga is in the range of 0.1 to 0.25 wt %, the content of Al is in the range of 0.05 to 1.2 wt %, the content of B is in the range of 0.85 to 1.05 wt %, and the balance is Fe and other impurity elements. In some embodiments, R does not contain Ce and Gd.

The third aspect of the present disclosure provides NdFeB magnets prepared using the method described in the second aspect of the present disclosure.

Through the above technical solution, the present disclosure increases the addition of high melting point elements such as Ti, Zr, and Nb while reasonably designing the remaining components. Coupled with the addition of low melting point elements such as Al, Cu, and Ga, the method employs a three-stage aging treatment at specific temperatures for compacts with high contents of Ti, Zr, Nb, and W. This approach can avoid the adverse effects of high contents of high melting point elements like Ti, Zr, and Nb on the grain morphology of the main phase and the magnetic properties of the magnets, further optimizing the microstructure of the magnets. The present disclosure effectively eliminates sharp tips of the main phase grains, improves the roundness of the main phase grains, and promotes further spheroidization of the main phase grains, thereby enhancing the recovery of the main phase grains and increasing the area fraction of the triangular grain boundary phases. Meanwhile, the eliminated tips of the main phase grains participate in intergranular reactions, and the area fraction of the thin-layer grain boundary phases decreases, allowing some low melting point metal elements in the thin-layer grain boundary phases to enter the intergranular space and participate in reactions. This results in the formation of R-T-M-Co phase with a high Co content within the triangular grain boundary phases, endowing the NdFeB magnets with high coercivity and squareness. Additionally, the magnets of the present disclosure contain a higher content of M₁ elements such as Ti and Zr, which can partially replace heavy rare earth elements like Dy and Tb, thereby reducing the usage of heavy rare earth elements.

Other features and advantages of the present disclosure will be described in detail in the following specific embodiments.

### BRIEF DESCRIPTION OF DRAWINGS

The figures included in this present disclosure are provided to enhance the understanding of the present disclosure. The illustrative embodiments and their descriptions herein are intended to elucidate the present disclosure and do not impose any undue limitations thereon.

FIG. 1 is a SEM image of the magnet prepared in Embodiment 1 of the present disclosure.

FIG. 2 is a SEM image of the magnet prepared in Comparative Embodiment 1 of the present disclosure.

### DETAILED DESCRIPTION OF EMBODIMENTS

The following detailed description of specific embodiments of the present disclosure is made in conjunction with the accompanying drawings. It should be understood that the specific embodiments described herein are for illustrative and explanatory purposes only and are not intended to limit the scope of the present disclosure.

The first aspect of the present disclosure provides a NdFeB magnet, where the NdFeB magnet comprises main phase grains, a thin-layer grain boundary phase, and a triangular grain boundary phase. The distribution of the triangular grain boundary phase within the NdFeB magnet satisfies the following:

$$0.057 \leq {S}_{1} / S \leq 0.073 ;$$

where S₁/S represents the ratio of the area S₁ of all triangular grain boundary phases to the total area S of the cross-section of the NdFeB magnet.

The NdFeB magnet comprises R, M, M₁, Co, B, and T; R represents one or more selected from Nd, Pr, Ho, Ce, Gd, Dy, and Tb; M represents one or more selected from Al, Cu, and Ga; M₁ represents one or more selected from Ti, Zr, Nb, W, and V; T is selected from Fe and other impurity elements. The content of R in the NdFeB magnet is in the range of 28 to 32 wt %, and the content of M₁ in the NdFeB magnet is in the range of 0.4 to 1.0 wt %.

The triangular grain boundary phase comprises an R-T-M-Co phase, where the content of Co in the R-T-M-Co phase is in the range of 6.2 to 10.4 at %. In this disclosure, wt % represents weight percentage and at % represents atomic percentage.

The microstructure of the NdFeB magnets provided by the present disclosure has been effectively optimized. The sharp tips of the main phase grains can be effectively eliminated, increasing the roundness of the main phase grains, and further promoting the spheroidization of the main phase grains. This enhances the recovery of the main phase grains and increases the area fraction of the triangular grain boundary phases. At the same time, the eliminated sharp tips of the main phase grains can participate in intergranular reactions, resulting in a decreased area fraction of the thin-layer grain boundary phases. Some low melting point metal elements from the thin-layer grain boundary phases enter the intergranular space to participate in reactions, leading to the formation of an R-T-M-Co phase within the triangular grain boundary phases, with an increased atomic percentage of Co in the R-T-M-Co phase, thereby endowing the NdFeB magnets with high coercivity and squareness.

In the present disclosure, the S₁/S value of the NdFeB magnets can be represented by the average S₁/S values obtained from multiple cross-sections of the NdFeB magnet. Specifically, S₁/S values can be determined by randomly selecting multiple different cross-sections of the NdFeB magnet and measuring the S₁/S value for each. The average of the S₁/S values from these different cross-sections represents the S₁/S value of the NdFeB magnet.

For example, the S₁/S value of the NdFeB magnets can be measured using the following method: perform scanning electron microscopy (SEM) testing on at least five arbitrary cross-sections of the NdFeB magnet, statistically analyze the area of all triangular grain boundary phases within each cross-section, calculate the S₁/S value for each cross-section, and then compute the average of all the S₁/S values from the cross-sections to determine the S₁/S value of the NdFeB magnet. The dimensions of the observation area may be, for example, 40 μm×40 μm and 75 μm×75 μm, with a magnification range of 2000 to 5000 times.

In some embodiments, the S₁/S value is in the range of 0.058 to 0.072. Exemplarily, S₁/S may take any value within the range formed by 0.058, 0.060, 0.062, 0.064, 0.066, 0.068, 0.070, 0.072, or any two of these values.

In some embodiments, in the NdFeB magnet, the content of R is in the range of 28 to 32 wt %, the content of M₁ is in the range of 0.4 to 1.0 wt %, the content of Co is in the range of 0.4 to 2 wt %, the content of Cu is in the range of 0.1 to 0.25 wt %, the content of Ga is in the range of 0.1 to 0.25 wt %, the content of Al is in the range of 0.05 to 1.2 wt %, the content of B is in the range of 0.85 to 1.05 wt %, with the remainder being Fe and other impurity elements. In some embodiments, R does not contain Ce and Gd.

In some embodiments, the content of R in the NdFeB magnet is 28 wt %, 28.5 wt %, 29 wt %, 29.5 wt %, 30 wt %, 30.5 wt %, 31 wt %, 31.5 wt %, 32 wt %, or any range formed by any two of these values.

In some embodiments, the content of M₁ in the NdFeB magnet is 0.4 wt %, 0.5 wt %, 0.6 wt %, 0.7 wt %, 0.8 wt %, 0.9 wt %, 1.0 wt %, or any value within any range formed by any two of these values.

In some embodiments, the content of Ti in M₁ is in the range of 0 to 0.4 wt %, and the content of Zr is in the range of 0.25 to 0.7 wt %.

In some embodiments, M₁ includes at least one of Ti or Zr, and optionally includes one or more of Nb, W, and V.

In some embodiments, when the content of Ti in M₁ is 0, the content of Zr is 0.3 wt % or higher.

In some embodiments, when the content of Zr in M₁ is 0, the content of Ti is 0.2 wt % or higher.

In some embodiments, the Co content in the R-T-M-Co phase is in the range of 6.3 to 10.3 at %. Exemplarily, the Co content in the R-T-M-Co phase is 6.3 at %, 6.5 at %, 7 at %, 7.5 at %, 8 at %, 8.5 at %, 9 at %, 9.5 at %, 10 at %, 10.3 at %, or any value within any range formed by any two of these values.

In some embodiments, the content of R in the R-T-M-Co phase is in the range of 38 to 90 at %. Exemplarily, the content of R in the R-T-M-Co phase is 38 at %, 40 at %, 45 at %, 50 at %, 55 at %, 60 at %, 65 at %, 70 at %, 75 at %, 80 at %, 85 at %, 90 at %, or any value within any range formed by any two of these values.

In some embodiments, the content of Cu in the R-T-M-Co phase is in the range of 4 to 9.7 at %, and the content of Ga is in the range of 2.9 to 6 at %. Exemplarily, the content of Cu in the R-T-M-Co phase is 4 at %, 4.5 at %, 5 at %, 5.5 at %, 6 at %, 6.5 at %, 7 at %, 7.5 at %, 8 at %, 8.5 at %, 9 at %, 9.5 at %, 9.7 at %, or any range formed by any two of these values; the content of Ga in the R-T-M-Co phase is 2.9 at %, 3.2 at %, 3.5 at %, 4 at %, 4.5 at %, 5 at %, 5.5 at %, 6 at %, or any value within any range formed by any two of these values. In some embodiments, the R-T-M-Co phase with high Cu and Ga contents helps hinder the propagation of demagnetizing fields between grains, further effectively improving the microstructural uniformity of the NdFeB magnet, achieving fine-grained control of the grain boundary structure, enhancing the demagnetization coupling effect, repairing surface defects of the main phase grains, and enabling the magnet to have high coercivity and excellent magnetic properties.

In some embodiments, the distribution of the R-T-M-Co phase within the triangular grain boundary satisfies the following:

$$0.162 \leq {S}_{2} / {S}_{1} \leq 0.18 ;$$

where S₂/S₁ represents the ratio of the area S₂ of all R-T-M-Co phases within the triangular grain boundary phase in the cross-section of the NdFeB magnet to the area S₁ of all triangular grain boundary phases in the cross-section. In some embodiments, R-T-M-Co phase with a high Co content enables the NdFeB magnet to have high coercivity and squareness. Exemplarily, S₂/S₁ is 0.162, 0.164, 0.166, 0.168, 0.17, 0.172, 0.174, 0.176, 0.178, 0.18, or any value within any range formed by any two of these values.

In the present disclosure, the S₂/S₁ value of the NdFeB magnet may be represented by the average result of S₂/S₁ values from multiple cross-sections of the magnet. That is, multiple different cross-sections of the NdFeB magnet may be randomly selected to measure their respective S₂/S₁ values, and the average of the S₂/S₁ values of these multiple different cross-sections represent the S₂/S₁ value of the NdFeB magnet.

For example, the following method may be used to measure the S₂/S₁ value of the NdFeB magnet: performing scanning electron microscopy (SEM) tests on at least five arbitrary cross-sections of the NdFeB magnet, statistically analyzing the area of all R-T-M-Co phases within the triangular grain boundaries of each cross-section, calculating the S₂/S₁ value for each cross-section, and then determining the average of the S₂/S₁ values of all cross-sections as the S₂/S₁ value of the NdFeB magnet. The observation area may be, for example, 40 μm×40 μm and 75 μm×75 μm; the magnification may be 2000 to 5000 times.

In some embodiments, the triangular grain boundary phase further includes an R₆T₁₃M₁ phase, and the distribution of the R₆T₁₃M₁ phase within the triangular grain boundary phase satisfies 0.8≤S₃/S₁≤0.815; where S₃/S₁ represents the ratio of the area of all R₆T₁₃M₁ phases in the NdFeB magnet to the area of all triangular grain boundary phases in the cross-section.

According to the present disclosure, the main phase grains of the magnet have high roundness, which helps further increase the area proportion of the triangular grain boundary phase, promote the formation of the R-T-M-Co phase, and reduce the area proportion of the thin-layer grain boundary phase. In some embodiments, the roundness of the main phase grains is in the range of 0.6 to 0.9, in some embodiments 0.65 to 0.9. Exemplarily, the roundness of the main phase grains may be 0.6, 0.65, 0.7, 0.75, 0.8, 0.85, 0.9, or any value within any range formed by any two of these values.

In the present disclosure, the roundness of the main phase grains is calculated using the following:

$$Roundness = 4 π {S}_{4} / {C}^{2} ;$$

where S₄ is the cross-sectional area of the main phase grains in the NdFeB magnet and C is the perimeter of the main phase grains in the NdFeB magnet.

The roundness of the main phase grains can be represented by the average roundness obtained from multiple cross-sections of the magnet. Specifically, roundness values can be determined by randomly selecting multiple different cross-sections of the magnet and measuring the roundness of the main phase grains within each cross-section. The average roundness of the main phase grains from these different cross-sections represents the roundness of the main phase grains of the NdFeB magnet.

In some embodiments, the average grain size of the main phase grains is in the range of 3.5 to 4.5 μm. Exemplarily, the average grain size of the main phase grains may be 3.5 μm, 3.7 μm, 3.9 μm, 4.1 μm, 4.3 μm, 4.5 μm, or any value within the range formed by any two of these values.

In this present disclosure, the average grain size refers to the mean value of the equivalent circular diameter calculated from the cross-sectional area of the main phase grains.

A second aspect of the present disclosure provides a method for preparing a NdFeB magnet, which comprises:
forming raw alloy powder into a compact;
sintering the compact; and aging the compact;
where the process of aging the compact includes a first aging treatment, a second aging treatment, and a third aging treatment;
where the temperature of the first aging treatment is in the range of 870 to 940° C. with a holding time of 0.5 to 4 h; the temperature of the second aging treatment is in the range of 420 to 670° C. with a holding time of 1 to 10 h; and the temperature of the third aging treatment is in the range of 620 and 670° C. with a holding time of 1 to 10 h;
where the raw alloy powder comprises R, M, M₁, Co, B, and T, with R representing one or more selected from of Nd, Pr, Ho, Ce, Gd, Dy, and Tb; M representing one or more selected from of Al, Cu, and Ga; M₁ representing one or more selected from of Ti, Zr, Nb, W, and V; and T selected from Fe and other impurity elements; and where the content of R in the NdFeB magnet is in the range of 28 to 32 wt %, and the content of M₁ is in the range of 0.4 to 1.0 wt %.

This present disclosure relates to performing a three-stage aging treatment at specific temperatures on compacts with high contents of high-melting-point elements such as Ti, Zr, and Nb. This treatment can avoid the adverse effects of high contents of high-melting-point elements like Ti, Zr, and Nb on the grain morphology of the main phase and the magnetic properties of the magnet. It further optimizes the microstructural organization of the magnet to achieve the regulation of the fine structural characteristics of the magnet's grain boundaries.

The method of the present disclosure can effectively eliminate the tips of the main phase grains of the NdFeB magnet and improve the roundness of the main phase grains, thereby further spheroidizing the main phase grains. It can effectively enhance the repair effect of the main phase grains and increase the area proportion of the grain boundary phase in the triangular region. At the same time, the eliminated tips of the main phase grains can participate in intergranular reactions, and the area proportion of the thin-layer grain boundary phase is reduced. Some low-melting-point metal elements in the thin-layer grain boundary phase enter the intergranular region to participate in reactions, so that the R-T-M-Co phase with a high Co content is formed in the triangular grain boundary phase, endowing the NdFeB magnet with high coercivity and squareness. In addition, the NdFeB magnet of the present disclosure has a relatively high content of M₁ containing elements such as Ti and Zr, which can replace part of Dy and Tb and reduce the usage amount of heavy rare earths.

For example, the temperature for the first aging treatment can be any value within a range composed of any two or more of the following temperatures: 870° C., 875° C., 880° C., 885° C., 890° C., 895° C., 900° C., 905° C., 910° C., 915° C., 920° C., 925° C., 930° C., 935° C., or 940° C.

In some embodiments, the temperature for the second aging treatment is in the range of 450 to 660° C. For example, the temperature for the second aging treatment may be any value within a range composed of any two or more of the following temperatures: 450° C., 455° C., 460° C., 465° C., 470° C., 475° C., 480° C., 485° C., 490° C., 495° C., 500° C., 505° C., 510° C., 515° C., 520° C., 525° C., 530° C., 535° C., 540° C., 545° C., 550° C., 555° C., 560° C., 565° C., 570° C., 575° C., 580° C., 585° C., 590° C., 595° C., 600° C., 605° C., 610° C., 615° C., 620° C., 625° C., 630° C., 635° C., 640° C., 645° C., 650° C., 655° C., or 660° C.

In some embodiments, the temperature for the third aging treatment is in the range of 630 to 670° C. For example, the temperature for the third aging treatment may be any value within a range composed of any two or more of the following temperatures: 630° C., 635° C., 640° C., 645° C., 650° C., 655° C., 660° C., 665° C., or 670° C.

In some embodiments, the temperatures for the second and third aging treatments can further mitigate the adverse effects of high concentrations of high-melting-point elements such as Ti, Zr, and Nb on the morphology of the main phase grains and the magnetic properties of the magnet. This further optimizes the microstructure of the magnet, resulting in a magnet with improved coercivity and squareness.

In some embodiments, in the raw material alloy powder, the content of R is in the range of 28 to 32 wt %, the content of M₁ is in the range of 0.4 to 1.0 wt %, the content of Co is in the range of 0.4 to 2 wt %, the content of Cu is in the range of 0.1 to 0.25 wt %, the content of Ga is in the range of 0.1 to 0.25 wt %, the content of Al is in the range of 0.05 to 1.2 wt %, the content of B is in the range of 0.85 to 1.05 wt %, with the remainder being Fe and other impurity elements. In some embodiments, R does not contain Ce and Gd.

In some embodiments, the method further includes: employing a rapid solidification process to prepare raw material alloy strips, subjecting the raw material alloy strips to hydrogen crushing treatment and air jet milling to obtain the raw material alloy powder; the D50 particle size of the raw material alloy powder is in the range of 2 to 5 μm. For example, the D50 particle size of the raw material alloy powder may be any value within a range composed of any two or more of the following sizes: 2 μm, 2.5 μm, 3 μm, 3.5 μm, 4 μm, 4.5 μm, or 5μ m.

In some embodiments, the forming treatment is an orientation forming treatment, which is conducted under conditions of an orientation magnetic induction strength of 1.8 to 2.5 T. For example, the orientation magnetic induction strength may be any value within a range composed of any two or more of the following values: 1.8 T, 1.9 T, 2.0 T, 2.1 T, 2.2 T, 2.3 T, 2.4 T, or 2.5 T.

In some embodiments, the temperature for the sintering treatment is in the range of 1030 to 1120° C., with a holding time of 1 to 10 hours. For example, the temperature for the sintering treatment may be any value within a range composed of any two or more of the following temperatures: 1030° C., 1040° C., 1050° C., 1060° C., 1070° C., 1080° C., 1090° C., 1100° C., 1110° C., or 1120° C.

The third aspect of the present disclosure provides a NdFeB magnet prepared using the method described in the second aspect of the disclosure.

The NdFeB magnet obtained using the method provided by the present disclosure has high coercivity and squareness.

The present disclosure will be further illustrated by the following embodiments; however, the present disclosure is not limited in any way by these embodiments.

### Embodiment 1

S1. The raw material alloy powder is prepared using the following steps:

(1) The raw material alloy powder is configured in mass percentages (wt %) as follows: R is a combination of Pr and Nd, M includes Al, Cu, and Ga, and M₁ includes Zr. R is 30 wt %, M₁ (Zr) is 0.5 wt %, Ga is 0.2 wt %, Cu is 0.1 wt %, Co is 0.9 wt %, Al is 0.5 wt %, B is 0.92 wt %, with the remainder being Fe. The prepared raw material alloy powder is cast into raw material alloy strips using a rapid solidification process. The raw material alloy strips undergo hydrogen crushing and micronization to obtain the raw material alloy powder, where the hydrogen absorption pressure during the hydrogen crushing is 0.3 MPa, the dehydrogenation temperature is 560° C., and the micronization is performed in a jet mill with a grinding pressure of 0.68 MPa. The average particle size (D50) of the raw material alloy powder is 4 μm.

S2. A NdFeB magnet is prepared using the obtained raw material alloy powder:

After subjecting the raw material alloy powder to forming treatment, sintering treatment, and aging treatment, a NdFeB magnet designated as CT-1 is obtained. The forming treatment is an orientation forming treatment conducted under a nitrogen gas atmosphere with an orientation magnetic induction strength of 2 T. The sintering treatment is performed in a vacuum or inert atmosphere at a temperature of 1080° C. for 8 hours, followed by gas quenching to room temperature. The aging treatment includes a first aging process, a second aging process, and a third aging process. The first aging process is conducted at a temperature of 940° C. for 1 hour, the second aging process is conducted at a temperature of 480° C. for 8 hours, and the third aging process is conducted at a temperature of 640° C. for 5 hours.

The microstructure of the prepared NdFEB magnet CT-1 is tested and analyzed. The results indicate that the NdFeB magnet CT-1 comprises primary phase grains and grain boundary phases. The grain boundary phases include thin-layer grain boundary phases and triangular zone grain boundary phases. The triangular zone grain boundary phase contains R-T-M-Co phase (bright grain boundary phase) and R₆T₁₃M₁ phase (gray grain boundary phase). The thin-layer grain boundary phase refers to the grain boundary phase formed between two adjacent primary phase grains, whereas the triangular zone grain boundary phase refers to the grain boundary phase surrounded by three or more primary phase grains.

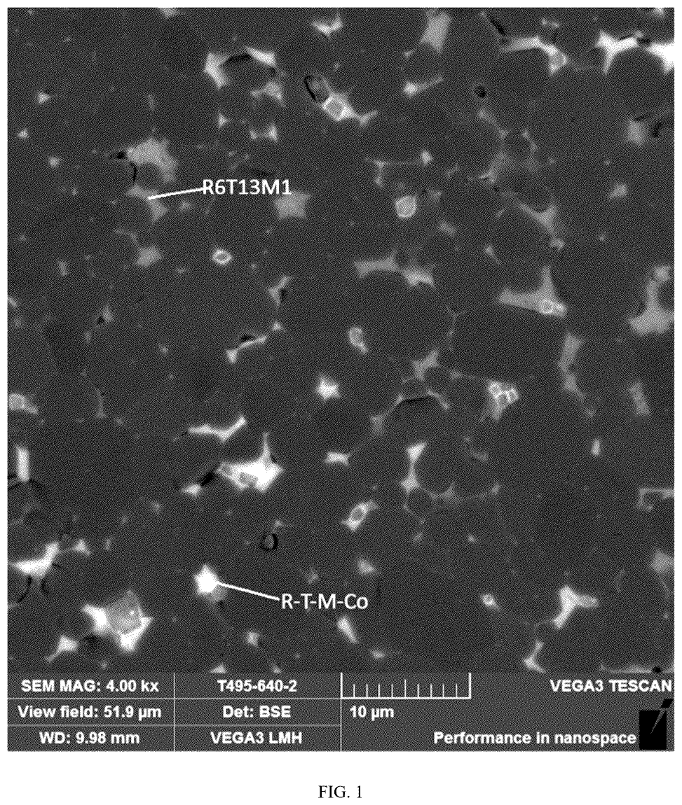

The distribution of the triangular zone grain boundary phase and the R-T-M-Co phase in the NdFeB magnet prepared in Embodiment 1 was statistically analyzed using image analysis software (Image Pro Plus). The results indicate that the ratio of the area of the triangular zone grain boundary phase to the total area (S₁/S) is 0.072, the ratio of the area of the R-T-M-Co phase to the triangular zone grain boundary phase (S₂/S1) is 0.165, and the ratio of the area of the remaining grain boundary phase to the triangular zone grain boundary phase (S₃/S1) is 0.802. The results are shown in FIG. 1, indicating that the area fraction of the triangular zone grain boundary phase is relatively high, and the primary phase grains exhibit a higher roundness. This contributes to the NdFeB magnet having enhanced coercivity and squareness.

### Embodiment 2

The method of Embodiment 1 is employed, with the only difference being that the temperature for the second aging treatment is set at 670° C., resulting in the NdFeB magnet designated as CT-2.

### Embodiment 3

The method of Embodiment 1 is employed, with the only difference being that the temperature for the second aging treatment is set at 420° C., and the temperature for the third aging treatment is set at 670° C., resulting in the NdFeB magnet designated as CT-3.

### Embodiment 4

The method of Embodiment 1 is employed, with the only difference being that the temperature for the second aging treatment is set at 630° C., resulting in the NdFeB magnet designated as CT-4.

### Embodiment 5

The preparation method of Embodiment 1 is referenced, with the difference being in step S₁, where the raw material alloy powder is configured in mass percentages (wt %) as follows: R is set at 28.5 wt %, where R consists of Pr and Nd, M₁ is set at 1.0 wt %, with M₁ including 0.6 wt % Zr and 0.4 wt % Ti; Ga is set at 0.1 wt %, Cu at 0.15 wt %, Co at 2 wt %, Al at 1 wt %, B at 0.94 wt %, with the remainder being Fe. This results in the NdFeB magnet designated as CT-5.

### Embodiment 6

The preparation method of Embodiment 1 is referenced, with the difference being in step S₁, where the raw material alloy powder is configured in mass percentages (wt %) as follows: R is set at 30 wt %, where R consists of Pr and Nd, M₁ is set at 0.4 wt %, with M₁ including 0.3 wt % Ti and 0.1 wt % Zr; Ga is set at 0.2 wt %, Cu at 0.2 wt %, Co at 0.6 wt %, Al at 1 wt %, B at 0.88 wt %, with the remainder being Fe. This results in the NdFeB magnet designated as CT-6.

### Comparative Embodiment 1

The preparation method of Embodiment 1 is referenced, with the difference being in step S₂, where the aging treatment includes a first aging treatment and a second aging treatment.

The temperature for the first aging treatment is set at 890° C. with a holding time of 4 hours; the temperature for the second aging treatment is set at 500° C. with a holding time of 8 hours, resulting in the NdFeB magnet designated as DCT-1.

### Comparative Embodiment 2

The preparation method of Embodiment 1 is referenced, with the difference being in step S₂, where the temperature for the second aging treatment is set at 680° C. with a holding time of 8 hours, resulting in the NdFeB magnet designated as DCT-2.

### Comparative Embodiment 3

The preparation method of Embodiment 1 is referenced, with the difference being in step S₂, where the temperature for the third aging treatment is set at 600° C. with a holding time of 8 hours, resulting in the NdFeB magnet designated as DCT-3.

### Comparative Embodiment 4

The preparation method of Embodiment 1 is referenced, with the difference being in step S₁, where the raw material alloy powder is configured in mass percentages (wt %) as follows: M₁ is set at 0.3 wt %, with M₁ including 0.1 wt % Zr and 0.2 wt % Ti. This results in the NdFeB magnet designated as DCT-4.

### Test Embodiments

NdFeB magnets prepared in Embodiments 1-6 and Comparative Embodiments 1˜4 were selected for analysis. The elemental atomic percentages of the grain boundary phases were determined using EPMA scanning tests. The results are presented in Tables 1 and 2.

The average particle size of the raw material alloy powder was measured using a particle size analyzer.

After preparing the magnet from Embodiment 1, cross-sectional images were captured using a scanning electron microscope (SEM), as shown in FIG. 1. The observation surface is oriented perpendicular to the direction of magnet alignment. The grain boundary phases in the triangular region of the magnet from Embodiment 1 include the R-T-M-Co phase (high bright white) and the R₆T₁₃M₁ phase (gray). The R-T-M-Co phase and the R₆T₁₃M₁ phase can be differentiated based on the electron backscatter image, where the backscatter electron image of the R-T-M-Co phase exhibits slightly higher contrast than that of the R₆T₁₃M₁ phase.

The size and roundness of the main phase grains were statistically analyzed using Image-Pro Plus image analysis software. More than five random cross-sections of the magnet were selected for analysis. For each cross-section, more than five random areas of 40 μm×40 μm were chosen (with a total of over 200 main phase grains counted within the field of view).

The average size and roundness of all complete main phase grains within each area were measured, and the average size and average roundness of the main phase grains across all areas were calculated to represent the average size and roundness of the main phase grains for that magnet.

The distribution of the grain boundary phases in the triangular region of the magnet, as well as the R-T-M-Co phase and R₆T₁₃M₁ phase within that triangular region, can be statistically analyzed using Image-Pro Plus image analysis software. More than five random cross-sections of the magnet were selected for analysis. For each cross-section, more than five random areas of 40 μm×40 μm were chosen (with a total of over 200 main phase grains counted within the field of view). The areas of the triangular region grain boundary phase (S1), the R-T-M-Co phase (S2), and the R₆T₁₃M₁ phase (S3) for each area, along with the total area(S) of each region, were measured. The ratio S₁/S was calculated for each area, and the average value was taken as the S₁/S value for that cross-section. The average S₁/S value across all cross-sections was then calculated to represent the S₁/S value for the NdFeB magnet. Similarly, the S₂/S₁ and S₃/S₁ values for the magnet were determined, with the results presented in Table 2.

The magnetic properties of the NdFeB magnets from Embodiments 1-6 and Comparative Embodiments 1˜4 were tested using a B-H curve measurement instrument, with the results shown in Table 3.

TABLE 1

| No. | R | M₁ | Co | Cu | Ga | Al | B | Fe |
|---|---|---|---|---|---|---|---|---|
| Embodiments | 30 | 0.5 | 0.9 | 0.1 | 0.2 | 0.5 | 0.92 | Balance |
| 1-4 | | | | | | | | |
| Embodiment 5 | 28.5 | 1 | 2 | 0.15 | 0.1 | 1 | 0.94 | Balance |
| Embodiment 6 | 30 | 0.4 | 0.6 | 0.2 | 0.2 | 1 | 0.88 | Balance |
| Comparative | 30 | 0.5 | 0.9 | 0.1 | 0.2 | 0.5 | 0.92 | Balance |
| Embodiments | | | | | | | | |
| 1-3 | | | | | | | | |
| Comparative | 30 | 0.3 | 0.9 | 0.1 | 0.2 | 0.5 | 0.92 | Balance |
| Embodiment 4 | | | | | | | | |

TABLE 2

| | | | Main Phase Grains | | R-T-M-Co Phase Composition (at %) | | | |
|---|---|---|---|---|---|---|---|---|
| No. | S₁/S | S₂/S₁ | Size(μm) | Roundness | Co | R | Cu | Ga |
| Embodiment 1 | 0.072 | 0.165 | 4.2 | 0.65 | 9.72 | 49.32 | 5.48 | 3.11 |
| Embodiment 2 | 0.068 | 0.168 | 4.3 | 0.61 | 9.15 | 38.83 | 4.78 | 2.93 |
| Embodiment 3 | 0.064 | 0.170 | 4.3 | 0.60 | 10.1 | 54.82 | 8.34 | 4.63 |
| Embodiment 4 | 0.073 | 0.162 | 4.1 | 0.68 | 6.81 | 63.39 | 4.12 | 3.59 |
| Embodiment 5 | 0.068 | 0.169 | 4.4 | 0.61 | 9.93 | 44.41 | 6.86 | 3.93 |
| Embodiment 6 | 0.058 | 0.178 | 3.9 | 0.72 | 10.39 | 59.31 | 7.37 | 5.96 |
| Comparative | 0.055 | 0.224 | 4.55 | 0.55 | 2.96 | 37.18 | 8.71 | 2.84 |
| Embodiment 1 | | | | | | | | |
| Comparative | 0.049 | 0.315 | 5.0 | 0.51 | 5.73 | 33.45 | 3.19 | 2.54 |
| Embodiment 2 | | | | | | | | |
| Comparative | 0.050 | 0.294 | 4.58 | 0.56 | 2.16 | 22.16 | 2.92 | 1.97 |
| Embodiment 3 | | | | | | | | |
| Comparative | 0.034 | 0.215 | 4.4 | 0.51 | 4.69 | 18.62 | 3.42 | 2.51 |
| Embodiment 4 | | | | | | | | |

TABLE 3

| | Br(T) | HcJ(KA/m) | Hk/HcJ |
|---|---|---|---|
| Embodiment 1 | 1.380 | 1473 | 98% |
| Embodiment 2 | 1.382 | 1450 | 97.8% |
| Embodiment 3 | 1.379 | 1402 | 97.5% |
| Embodiment 4 | 1.380 | 1476 | 98.3% |
| Embodiment 5 | 1.382 | 1449 | 97.9% |
| Embodiment 6 | 1.375 | 1466 | 97.5% |
| Comparative Embodiment 1 | 1.383 | 1280 | 92.5% |
| Comparative Embodiment 2 | 1.375 | 1382 | 90.8% |
| Comparative Embodiment 3 | 1.382 | 1381 | 90.6% |
| Comparative Embodiment 4 | 1.375 | 1402 | 89.3% |

According to Tables 1-3, the present disclosure demonstrates that while increasing the addition of high melting point elements such as Ti, Zr, and Nb, the remaining components were reasonably designed. By incorporating low melting point elements such as Al, Cu, and Ga, and applying a three-stage aging treatment at specific temperatures to the compacts with high contents of Ti, Zr, Nb, and W, the adverse effects of high contents of high melting point elements on the morphology of the main phase grains and the magnetic properties of the NdFeB magnets can be avoided. This further optimizes the microstructure of the NdFeB magnets, allowing for fine control of the magnetic domain boundary structure. The method disclosed herein effectively eliminates sharp tips of the main phase grains, increases the roundness of the main phase grains, promotes further spheroidization, and enhances the healing effect of the main phase grains. As a result, the triangular region grain boundary phase occupies a larger area in the magnets of embodiments 1-6. Additionally, the eliminated sharp tips of the main phase grains participate in intergranular reactions, which reduces the area ratio of the thin-layer grain boundary phase. Some of the low melting point metal elements in the thin-layer grain boundary phase enter into the intergranular reactions, leading to the formation of R-T-M-Co phases with higher Co content in the triangular grain boundary phase. Consequently, the coercivity and squareness of the NdFeB magnets produced in embodiments 1-6 are higher than those of comparative embodiments 1-4. Moreover, the NdFeB magnets disclosed herein contain a higher content of M₁ elements such as Ti and Zr, which can partially replace heavy rare earth elements such as Dy and Tb, thereby reducing the usage of heavy rare earth materials.

A comparison of embodiment 2 with embodiment 1 and embodiment 4 shows that controlling the temperature of the second aging treatment within the range of this disclosure can further optimize the microstructure of the NdFeB magnets, improve the roundness of the main phase grains, promote additional spheroidization, and effectively enhance the healing effect of the main phase grains, resulting in further improvements in the coercivity and squareness of the NdFeB magnets.

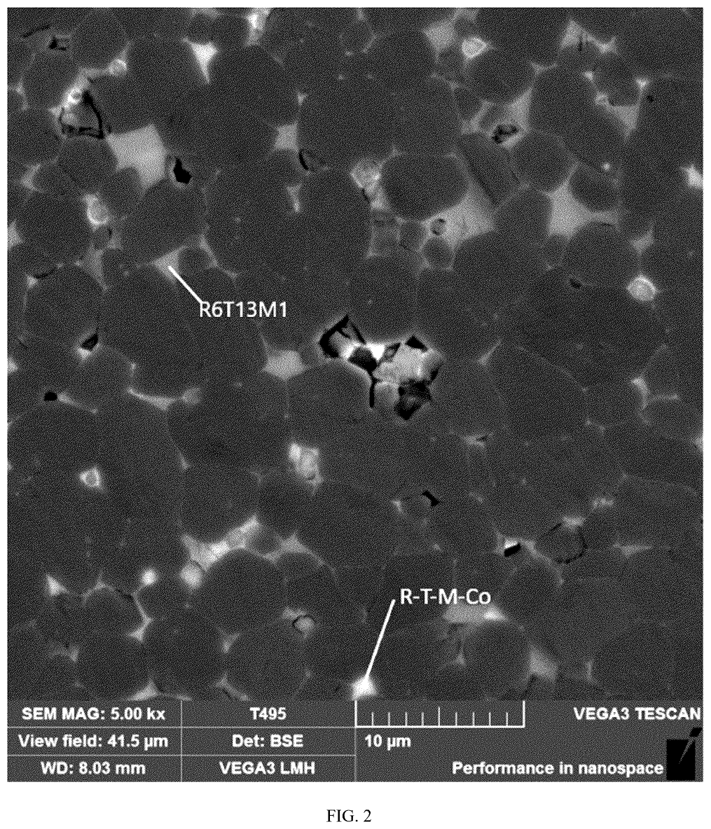

Comparing comparative embodiment 1 with embodiment 1, it can be seen that since only two-stage aging treatment is performed on the compact in comparative example 1, high-melting-point elements with high contents such as Ti, Zr, and Nb will have adverse effects on the morphology of the main phase grains and the magnetic properties of the magnet, and cannot effectively eliminate the tips of the main phase grains of the magnet. As shown in FIG. 2, the roundness of the main phase grains is relatively low, and the area ratio of the triangular region grain boundary phase in the magnet is lower than that in embodiments 1-6. Consequently, the area ratio of the thin-layer grain boundary phase increases, and some low melting point metal elements in the thin-layer grain boundary phase cannot participate in intergranular reactions, resulting in a lower Co content in the R-T-M-Co phase formed in the triangular grain boundary phase. This leads to a decrease in the coercivity and a significant reduction in the squareness of the magnet produced in comparative embodiment 1.

Comparisons of comparative embodiment 2 and comparative embodiment 3 with embodiment 1 show that when the temperatures of the second and third aging treatments are outside the defined range of this application, the adverse effects of high melting point elements such as Ti, Zr, and Nb on the morphology of the main phase grains and the magnetic properties of the magnets cannot be effectively controlled. The sharp tips of the main phase grains cannot be eliminated, resulting in low roundness of the main phase grains. The area ratio of the triangular region grain boundary phase in the magnets is also lower than that in embodiments 1-6. The area ratio of the thin-layer grain boundary phase increases, and some low melting point metal elements in the thin-layer grain boundary phase are unable to participate in intergranular reactions, contributing to a lower Co content in the R-T-M-Co phase formed in the triangular grain boundary phase. Thus, the coercivity of the NdFEB magnets produced in comparative embodiment 2 and embodiment 3 decreases, and their squareness significantly declines.

A comparison between comparative embodiment 4 and embodiment 1 indicates that when M is less than 0.4, the improvement in coercivity and squareness of the NdFeB magnets produced by this process is not significant.

The above detailed description, in conjunction with the accompanying drawings, illustrates some embodiments of the present disclosure. However, the present disclosure is not limited to the specific details of the embodiments described above. Within the scope of the technical concept of the present disclosure, various simple modifications can be made to the technical solutions of the present disclosure, and these simple modifications fall within the protection scope of the present disclosure.

It should also be noted that the various specific technical features described in the above-mentioned specific embodiments can be combined in any suitable manner, provided that there are no contradictions. To avoid unnecessary repetition, the present disclosure does not elaborate on all possible combinations.

Moreover, any combination of the various different embodiments of the present disclosure is also permissible, as long as it does not contravene the spirit of the disclosure, and such combinations should also be considered as part of the content disclosed by the present disclosure.

1. A NdFeB magnet comprising main phase grains, thin-layer grain boundary phases, and triangular region grain boundary phases;
wherein:
a distribution of the triangular region grain boundary phases within the NdFeB magnet satisfies 0.057≤S₁/S≤0.073, where S₁ represents an area of all of the triangular region grain boundary phases in a cross-section of the NdFeB magnet, and S represents a total area of the cross-section;
the NdFeB magnet includes R, M, M₁, Co, B, and T, where:
R represents one or more selected from Nd, Pr, Ho, Ce, Gd, Dy, and Tb;
M represents one or more selected from Al, Cu, and Ga;
M₁ represents one or more selected from Ti, Zr, Nb, W, and V;
T represents one or more selected from Fe and other impurity elements; and
a content of R in the NdFeB magnet is in a range of 28 to 32 wt %, and a content of M₁ in the NdFeB magnet is in a range of 0.4 to 1.0 wt %; and
the triangular grain boundary phases include R-T-M-Co phases, and a content of Co in the R-T-M-Co phases is in a range of 6.2 to 10.4 at %.

2. The NdFeB magnet according to claim 1, wherein in the NdFeB magnet, a content of M₁ is in a range of 0.4 to 1 wt %, a content of Co is in a range of 0.4 to 2 wt %, a content of Cu is in a range of 0.1 to 0.25 wt %, a content of Ga is in a range of 0.1 to 0.25 wt %, a content of Al is in a range of 0.05 to 1.2 wt %, a content of B is in a range of 0.85 to 1.05 wt %, with the remainder being Fe and other impurity elements.

3. The NdFeB magnet according to claim 1, wherein R does not contain Ce and Gd.

4. The NdFeB magnet according to claim 1, wherein a content of Ti in M₁ is in a range of 0 to 0.4 wt %, and a content of Zr is in a range of 0.25 to 0.7 wt %.

5. The NdFeB magnet according to claim 1, wherein M₁ includes at least one of Ti or Zr.

6. The NdFeB magnet according to claim 1, wherein a content of R in the R-T-M-Co phases is in a range of 38 to 90 at %.

7. The NdFeB magnet according to claim 1, wherein:
a content of Cu in the R-T-M-Co phases is in a range of 4 to 9.7 at %; and
a content of Ga in the R-T-M-Co phases is in a range of 2.9 to 6 at %.

8. The NdFeB magnet according to claim 1, wherein a distribution of the R-T-M-Co phases within the triangular region grain boundary satisfies 0.162≤S₂/S_{1≤0.18}, where S₂ represents an area of all of the R-T-M-Co phases within the triangular region grain boundary phases in the cross-section of the NdFeB magnet.

9. The NdFeB magnet according to claim 1, wherein:
the triangular grain boundary phases further include R₆T₁₃M₁ phases; and
a distribution of the R₆T₁₃M₁ phases within the triangular grain boundary phases satisfies 0.8≤S₃/S₁≤0.815, where S₃ represents an area of all of the R₆T₁₃M₁ phases in the cross-section of the NdFeB magnet.

10. The NdFeB magnet according to claim 1, wherein:
a roundness of the main phase grains is in a range of 0.6 to 0.9; and
an average grain size of the main phase grains is in a range of 3.5 to 4.5 μm.

11. A method for preparing the NdFeB magnet according to claim 1, comprising:
forming raw alloy powder into a compact; and
performing sintering process and aging process on the compact;
wherein
the aging process includes:
a first aging treatment performed at a temperature in a range of 870 to 940° C. with a holding time of 0.5 to 4 h;
a second aging treatment performed at a temperature in a range of 420 to 670° C. with a holding time of 1 to 10 h; and
a third aging treatment performed at a temperature in a range of 620 to 670° C. with a holding time of 1 to 10 h; and
the raw alloy powder includes R, M, M₁, Co, B, and T.

12. The method according to claim 11, wherein:
the temperature for the second aging treatment is in a range of 450 to 660° C.; and
the temperature for the third aging treatment is in a range of 630 to 670° C.

13. The method according to claim 11, wherein in the raw alloy powder:
a content of R is in a range of 28 to 32 wt %;
a content of M₁ is in a range of 0.4 to 1.0 wt %;
a content of Co is in a range of 0.4 to 2 wt %;
a content of Cu is in a range of 0.1 to 0.25 wt %;
a content of Ga is in a range of 0.1 to 0.25 wt %;
a content of Al is in a range of 0.05 to 1.2 wt %;
a content of B is in a range of 0.85 to 1.05 wt %; and
the remainder includes Fe and other impurity elements.

14. The method according to claim 11, wherein R does not contain Ce and Gd.
